(19) United States
(12) Patent Application Publication
(10) Pub. No.: US 2001/0039612 A1
(43) Pub. Date: Nov. 8, 2001

(54) Apparatus and method for fast booting

(76) Inventor: Sang-Jin Lee, Suwon (KR)

Correspondence Address: ROBERT E. BUSHNELL, 1522 K STREET NW, SUITE 300, WASHINGTON, DC, 200051202

(21) Appl. No.: 09/727,513

(22) Filed: Dec. 4, 2000

(30) Foreign Application Priority Data
Dec. 2, 1999 (KR) 54462/1999

(51) Int. Cl. G06F 9/445

(52) U.S. Cl. 713/2

(57) ABSTRACT

A computer system having a booting image storing device, which is capable of being composed of a hard disk drive, a memory, and a compact disk drive. An initial state of a main memory is converted to a boot image, and the boot image is stored to the boot image storing device, when the computer system is powered off. When the computer system is powered on, the booting image is read out from the boot image storing device without loading and referring respective drivers of hardware components whenever booting the system. The main memory can be supplied the power from an auxiliary power supply when a main power of the computer system is shut off.

### CLAIM OF PRIORITY

This application makes reference to, incorporates the same herein, and claims all benefits accruing under 35 U.S.C. §119 from my application COMPUTER SYSTEM AND METHOD FOR QUICKLY BOOTING filed with the Korean Industrial Property Office on Dec. 2, 1999, and there duly assigned Ser. No. 99-54462.

### BACKGROUND OF THE INVENTION

1. Field of the Invention

The present invention relates to a computer system, and more particularly to a fast bootable computer system.

2. Background of the Invention

A computer system normally includes a number of complex hardware components, such as a central processing unit (CPU), a main memory, a basic input output system read only memory (BIOS ROM), a hard disk drive (HDD), a floppy disk drive (FDD), an input device, a display, and so on.

The computer system is generally controlled and coordinated by an operating system (OS) program. Operating systems, for example Windows 95, Windows 98, Windows NT, Windows 2000, and Windows Millennium Edition of Microsoft Corporation, provide resource management throughout a computer system, including such tasks as process execution and scheduling, memory management, file system services, networking and I/O services, and user interface presentation. User applications, such as editors and spreadsheets, directly or indirectly, rely on these and other capabilities of the operating system.

The procedure for forcing a computer system into a known usable state—one from which computer applications may be executed—is generally called “booting.” The general term “booting,” however, may be further distinguished into “first boots,” “cold boots,” and “warm boots.” Each type depends upon the state of the system when the booting operation is performed.

A “first boot” is performed when a computer system is powered on for the very first time. At such time, the computer system has a “minimal” known state. For example, the software installed on the computer system prior to first boot does not generally include a copy of a complete operating system. If the system is already loaded with an operating system, a “cold boot” is performed when power is turned on. A cold boot requires fewer operations than a first boot, because the computer system has more known state prior to the boot operation. Among other things, the computer system already has a copy of the operating system installed in its associated local media, such as a nonvolatile disk.

If the operating system is already loaded and the system is already powered on, a user may cause a “warm boot” to occur to force the system into a particular start state. Typically, this is caused by a predefined sequence of key strokes. A warm boot needs even fewer steps than a cold boot.

Conventional computer systems provide a variety of hardware and software mechanisms to boot the computer system to a useful state. These mechanisms in the context of a first boot is described as follows. Afterwards, a cold and warm boot are distinguished from the first boot.

When power is applied to a computer system, a portion of the computer system typically called the “initialization hardware” electronically detects the “power-on” condition and, in response to such a detection, forces certain circuitry of the system to a known state. For example, the CPU typically includes an instruction pointer (IP), which holds a memory address from which the CPU fetches an instruction to be executed by the CPU. The initialization hardware typically electronically forces the IP to an initial address so that the CPU may begin fetching and executing instructions from this initial address. The ROM is prerecorded with computer instructions, referred to below as the “ROM-based code.” As a result, shortly after power on, the CPU begins executing the ROM-based code.

The ROM-based code attempts to establish communication with a so-called “boot device”. A boot device holds information that is necessary to boot the system. In attempting to establish communication with a boot device, the ROM-based code operates according to a so-called “boot order.” The boot order designates potential boot devices, such as a diskette and a local media. Currently, fixed disks are typically used as local media. However, as further described below, local media may employ other existing and future technologies. Typically, the first device listed in the boot order is a diskette. As such, the ROM-based code attempts to communicate with a diskette to determine if it is the boot device. More particularly, the ROM-based code attempts to retrieve a so-called “master boot record” from a particular sector of the diskette. If the communication attempt is successful, the ROM-based code uses that device as the boot device. If not, the ROM-based code proceeds to attempt communication with a device of the next boot order, e.g., local media.

In the case of a “first boot,” the boot device is typically a diskette inserted into the system. More particularly, a plurality of diskettes are often needed to store all of the information needed to boot the system, with each diskette inserted at an appropriate point in a sequence. The plurality of diskettes forms the boot device.

Assuming that the correct first diskette is inserted into the system, the ROM-based code retrieves the master boot record from sector 0 of the first diskette. The master boot record, among other things, typically includes information about the particular boot media, such as partitioning information for that diskette, and includes a pointer and an offset to a so-called operating system loader (“OS loader”). The ROM-based code then copies the OS loader into RAM from the first diskette, starting at the address indicated in the master boot record and continuing for a length indicated by the offset provided by the master boot record. After copying the OS loader into RAM, the ROM-based code jumps to the OS loader.

The OS loader is more sophisticated than the ROM-based code and performs certain preliminary functions, such as sizing memory. After performing preliminary functions, the OS loader copies into RAM a portion of the operating system known as the “kernel.”

The kernel provides certain core functionality of the operating system, such as memory management. After the kernel is copied into RAM, the OS loader jumps to a section of the kernel called “SYSTEM.INI.”

SYSTEM.INI performs other conventional preliminary functions, such as executing system diagnostics to ensure that the system is operating properly. These preliminary functions indicate whether continuation of the boot is worthwhile. For example, if a critical hardware fault is detected, a successful boot is unlikely and, therefore, continuation of the process is not worthwhile.

After performing preliminary functions, SYSTEM.INI reads from diskette an ASCII file called CONFIG.SYS. The CONFIG.SYS includes ASCII statements, describing, among other things, which devices may possibly be connected to the system. CONFIG.SYS also includes the name of the program that should be executed after SYSTEM.INI completes. This version of CONFIG.SYS is generic to the operating system; it is not tailored to the peculiar needs of a specific machine.

As SYSTEM.INI reads CONFIG.SYS, it loads device drivers into RAM in accordance with the ASCII statements. After loading a device driver, SYSTEM.INI invokes the device driver at an initialization entry point, which, among other things, causes the device driver to detect whether a corresponding component is connected to the computer system. This must be done because the generic version of CONFIG.SYS will likely include many ASCII statements for devices that are not connected in a particular system. For example, CONFIG.SYS may include a directive to load a device driver to communicate with a computer network. If the system is not connected to a computer network, the device driver initialization routine returns a status code indicating that the device driver was unable to communicate with a network. In response to such a status code, CONFIG.SYS unloads that device driver from memory, because it is not needed.

CONFIG.SYS also includes information, indicating where certain files are stored. This information is read by SYSTEM.INI and used to program data structures used by the kernel to determine where executable files, data files, dynamic linked libraries, and the like should be accessed.

As described above, the operating systems loads and refers the device drivers defined in the CONFIG.SYS and SYSTEM.INI files whenever the computer performs boot operation. Thus, the booting time of the computer system becomes longer, although the computer system equips a high speed CPU and peripheral devices.

To solve the problem, U.S. Pat. No. 5,325,532 to Wm. Caldwell Crosswy, et al., issued on Jun. 28, 1994, “Automatic Development Of Operating System Boot Image”; and U.S. Pat. No. 5,598,563 to Terence R. Spies, issued on Jan. 28, 1997, “Method OfLoading Device Drivers From ROM Without Requirement Of System To Have Any Hard-disks Or Floppy Drives And Without Using Config.sys File” disclose various methods for configuring a computer system and/or device drivers.

### SUMMARY OF THE INVENTION

It is therefore an object of the present invention to provide a computer system to reduce booting time.

It is another object of the invention to provide a method for shutting off and booting a computer system to reduce booting time.

In order to attain the above objects, according to an aspect of the present invention, there is provided a computer system having a central processing unit; a main and/or auxiliary power supply for supplying main and/or auxiliary power of the computer system; a boot image storing device for storing a boot image of the computer system; a main memory for storing the boot image from the boot image storing device by receiving the auxiliary power when the main power is shut off; and a composition memory for setting an instruction pointer of the central processing unit to a specific region of the main memory storing the boot image; wherein the central processing unit loads the boot image from the specific region of the main memory in response to the instruction pointer, thereby an operating system program can perform control functions.

According to another aspect of this invention, there is provided a method for powering down a computer system receiving main and auxiliary power and including a central processing unit, a main memory, a basic input/output system memory and a boot mage storing device, the method having the steps of: determining whether the computer system is powered down; reading out a boot image from the boot image storing device according to an initial state of the main memory, when the computer system is powered down; storing the read boot image to the main memory; and supplying the auxiliary power to the main memory and shutting off the main power, and a method for powering on a computer system receiving main and auxiliary power and including a central processing unit with an instruction pointer, a main memory storing a boot image by receiving the auxiliary power when the main power is shut off, and a basic input/output system memory setting the instruction pointer, the method including the steps of: checking initializing steps and faults of the hardware components of the computer system; setting the instruction pointer of the central processing unit to a boot image storing region of the main memory; and executing an operating system program by reading out the boot image from the boot image storing region of the main memory.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram for illustrating a structure of a computer system according to a first embodiment of the present invention;

FIG. 2 is a flow chart for illustrating a method for generating a boot image of the computer system shown in FIG. 1;

FIG. 3 is a flow chart for illustrating a method for booting the computer system shown in FIG.

FIG. 4 is a block diagram for illustrating a structure of a computer system according to a second embodiment of the present invention;

FIG. 5 is a flow chart for illustrating a method for booting the computer system shown in FIG.

FIG. 6 is a block diagram for illustrating a structure of a computer system according to a third embodiment of the present invention;

FIG. 7 is a flow chart for illustrating a method for powering down the computer system shown in FIG. 6; and

FIG. 8 is a flow chart for illustrating a booting method of the computer system shown in FIG. 6.

### DETAILED DESCRIPTION OF THE INVENTION

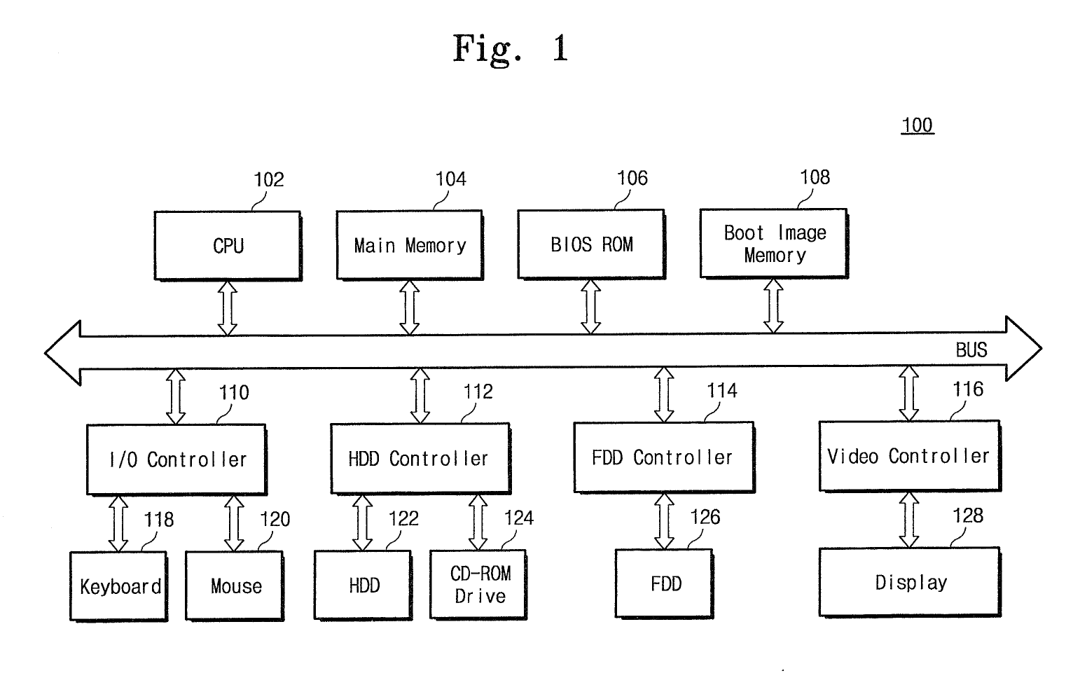

FIG. 1 is a block diagram for illustrating a structure of a computer system 100 according to a first embodiment of the present invention. Referring to FIG. 1, the computer system 100 includes a boot image memory 108. In addition, the computer system 100 includes a central processing unit (CPU) 102 including an instruction pointer (IP) for handling programs, a main memory 104 for reading and writing data under control of the CPU 102, and a BIOS ROM 106 containing an input/output program for arbitrating between the main memory 104 and hardware and software of the computer system 100.

The computer system 100 is an IBM compatible computer system, which includes a plurality of controllers (for example, an input/output (I/O) controller 110, a hard disk drive (HDD) controller 112, and a floppy disk drive (FDD) controller 114), input devices including a keyboard 118 and a mouse 120, and auxiliary storing devices including a hard disk drive (HDD) 122, a CD-ROM drive 124, a floppy disk drive (FDD) 126, and so on. Further, the computer system 100 includes a video controller 116, and a display 128. These hardware components are connected through a bus for performing interface with each other.

The boot image memory 108 is capable of containing a non-volatile memory such as a flash memory to store a compressed boot image data. The boot image data can be obtained by compressing an initial storing state of the main memory 104 as a data format. The initial storing state is capable of executing a certain application program in an operating system program environment. The state of the main memory 104 is called an initial state of main memory herein after.

The BIOS ROM 106 controls POST routine, interrupt processing, and system environment setting, according to initializing steps of the computer system 100. Especially, the BIOS ROM 106 sets the instruction pointer (IP).

The BIOS ROM 106 and the boot image memory 108 are capable of setting and storing an initial state of main memory by a manufacturer or a user. Thus, the CPU 102 can reduce a device drive loading time by reading out the compressed boot image from the boot image memory 108 and loading the boot image after decompressing, when boot image is loaded to the main memory 104.

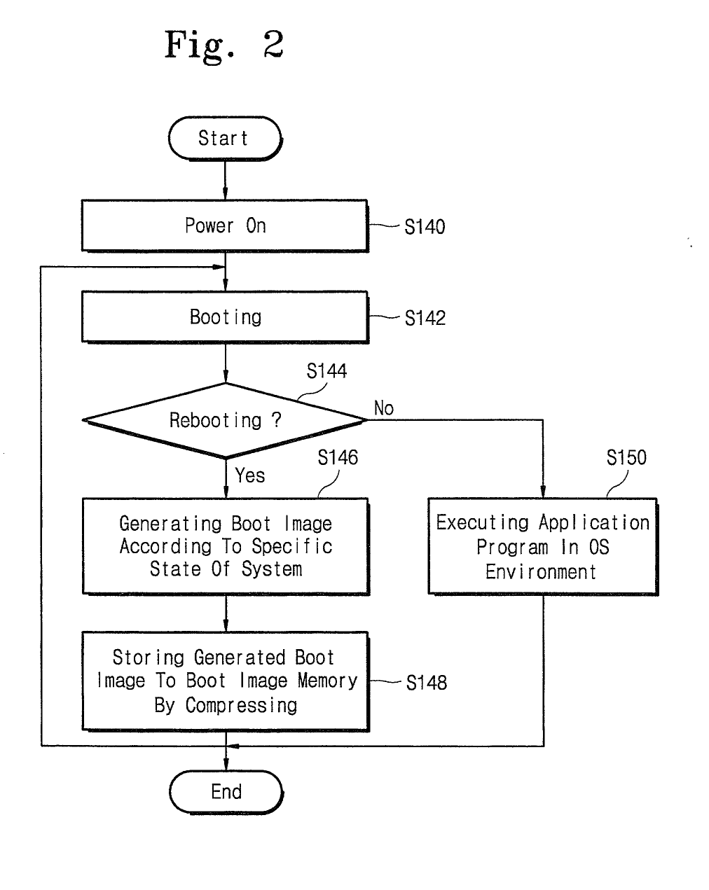

FIG. 2 is a flow chart for illustrating a method for generating a boot image of the computer system 100 shown in FIG. 1. The control flow is performed under control of the CPU 102.

Referring to FIG. 2, at step S140, the computer system 100 is powered on, and then the control flow proceeds to step S142, wherein the computer system 100 is booted. In other words, at the step S142, the CPU 102 executes the operating system if a successful boot is detected through a POST routine. Therefore, a certain application program can be executed in the operating system environment.

Continually, at step S144, it is determined whether the computer system 100 is rebooted or not to generate a boot image. If the computer system 100 is rebooted, the control flow proceeds to step S146, wherein the boot image corresponding to a specific state of the main memory 104 (for example, an initial state of a main memory 104) is generated. At step S148, the generated boot image is stored to the boot image memory 108 after compressing, and then the computer system 100 is rebooted. If the computer system 100 is not rebooted, the control flow proceeds to step S150, wherein application programs are performed in the operating system environment.

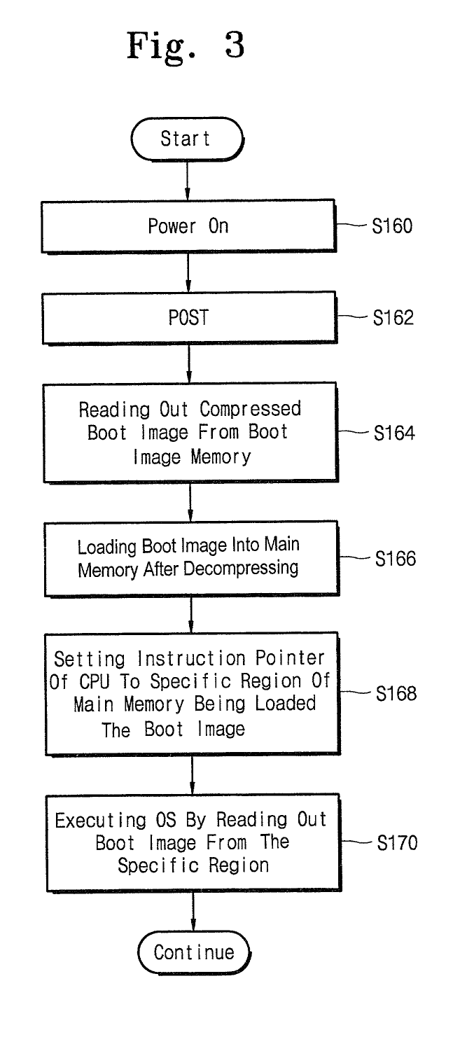

FIG. 3 is a flow chart for illustrating a method for booting the computer system 100 shown in FIG. 1. The control flow is a program stored in the BIOS ROM 106. The CPU 102 performs the program according to the processing steps of the BIOS ROM 106.

Referring to FIG. 3, the computer system 100 is powered on in step S160, and POST routine is performed in step S162. Continually, at step S164, the compressed boot image is read out. At step S166, the compressed boot image is loaded to the main memory 104 after decompressing. At step S168, an instruction pointer (IP) of the CPU 102 is set to a specific region of the main memory 104 being loaded the boot image. And then at step S170, the operating system is executed by reading out the boot image from the specific region. Therefore, application programs are set on a state to be started in the operating system environment.

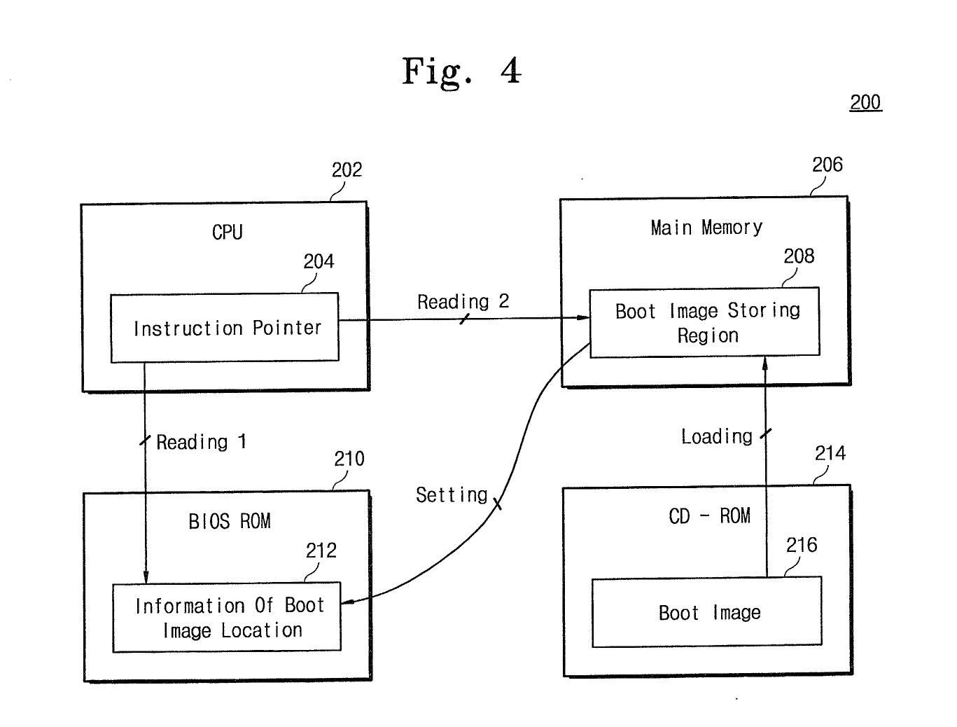

FIG. 4 is a block diagram for illustrating a structure of a computer system 200 according to a second embodiment of the present invention. Referring to FIG. 4, the computer system 200 includes a CD-ROM 214 as a novel boot image storing device. In addition, the computer system 200 includes a CPU 202, a main memory 206, a BIOS ROM 210, and general hardware components (not shown).

The CD-ROM 214 stores a compressed boot image 216 in a specific region. The BIOS ROM 210 controls so as an instruction pointer 204 of the CPU 202 can be set to a specific region 208 of the main memory 206, and stores location information of the specific region 208 for loading the boot image of the main memory 206.

The CPU 202 loads the boot image 216 from the CD-ROM 214 to the main memory 206 under control of the BIOS. In this case, the CPU 202 decompresses the compressed boot image from the CD-ROM 214, and loads it to a specific region 208 of the main memory 206. And then, the CPU 202 reads out the location information 212 of boot image from the BIOS ROM 210, and reads out the boot image from the specific region 208 of the main memory 206. As a result, an operating system can perform control functions by setting the instruction pointer 204 of the CPU 202 to the specific region 208 of the main memory 206.

As described above, the computer system 200 loads a boot image to a main memory by using a CD-ROM. The computer system 200 can provide facilities to a user as an easy computer and so on.

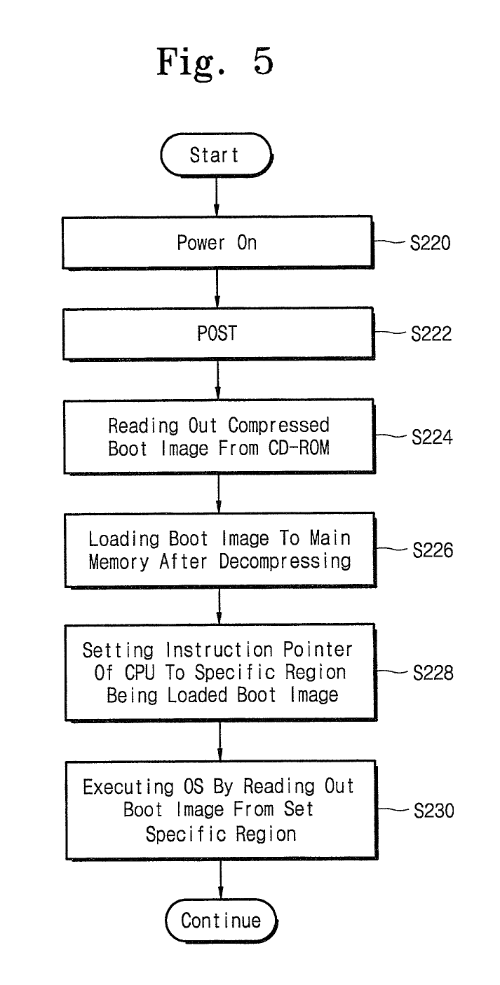

FIG. 5 is a flow chart for illustrating a method for booting the computer system 200 shown in FIG. 4. The control flow is a program stored in the BIOS ROM 210, and is executed by the CPU 202 according to processing steps of the BIOS.

Referring to FIG. 5, at step S220, the computer system 200 is powered on. And then POST routine is performed in step S222. Continually, at step S224, a compressed boot image 216 is loaded from the CD-ROM 214, and the boot image is loaded to the main memory 206 after decompressing in step S226. At step S228, an instruction pointer 204 of the CPU 202 is set to a specific region 208 of the main memory 206 being loaded the boot image. At step S230, the operating system is executed by reading out the boot image from the specific region 208 of the main memory 206. As a result, the operating system can perform control functions.

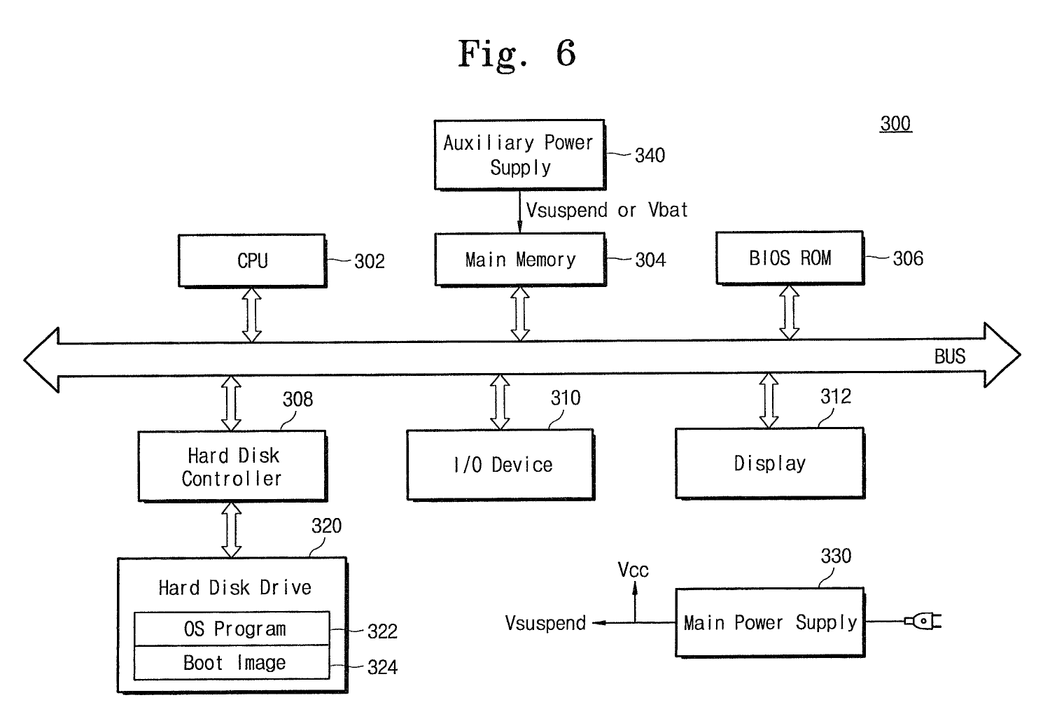

FIG. 6 is a block diagram for illustrating a structure of a computer system 300 according to a third embodiment of the present invention. Referring to FIG. 6, the computer system 300 includes a main power supply 330, an auxiliary power supply 340 (for example, a battery or a suspend power supplying unit of the main power supply), a CPU 302 including an IP, a main memory 304 receiving auxiliary power (for example, a battery voltage Vbat or a suspend voltage Vsuspend) from the auxiliary power supply 340 when a main power Vcc of the main power supply 330 is shut off, and a BIOS ROM 306 setting the IP. In addition, the computer system 300 further includes a hard disk controller 308, and a hard disk drive (HDD) 320 storing an operating system program 322 and boot image 324. Further, the computer system 300 includes input/output (I/O) devices including a keyboard, a mouse, and so on, and a display 312. The above mentioned hardware components are coupled electrically with each other through a bus.

The BIOS ROM 306 sets the IP of the CPU 302 to a specific region of the main memory 304, and stores a location information of a specific region to load the boot image of the memory 304.

The CPU 302 reads out the boot image 324 from the hard disk drive 320 and loads it to the main memory 304, under control of the BIOS. In other words, the CPU 302 decompresses the compressed boot image from the specific region of the hard disk drive 320, and loads it to a specific region of the main memory 304. The CPU 302 reads out the location information of the boot image from the BIOS ROM 306, and then reads out the boot image from the specific region of the main memory 304 according to the information. Thus, the operating system can perform control functions 15 by setting the IP of the CPU 302 to the specific region of the main memory 304.

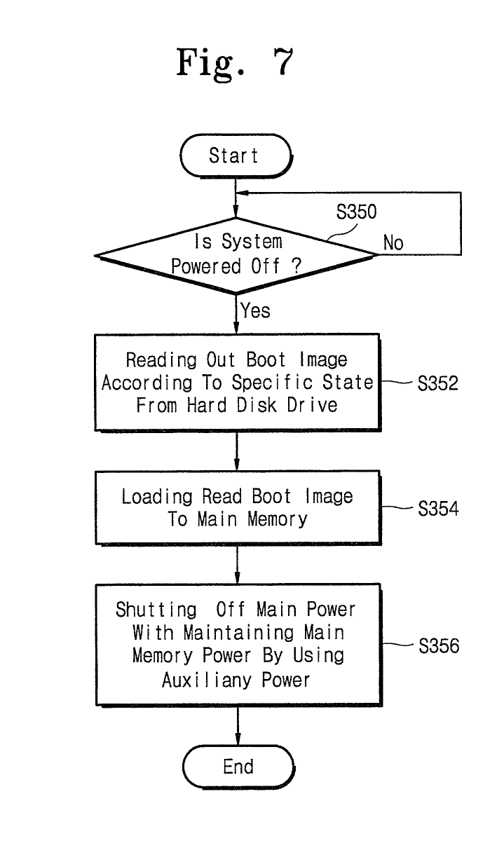

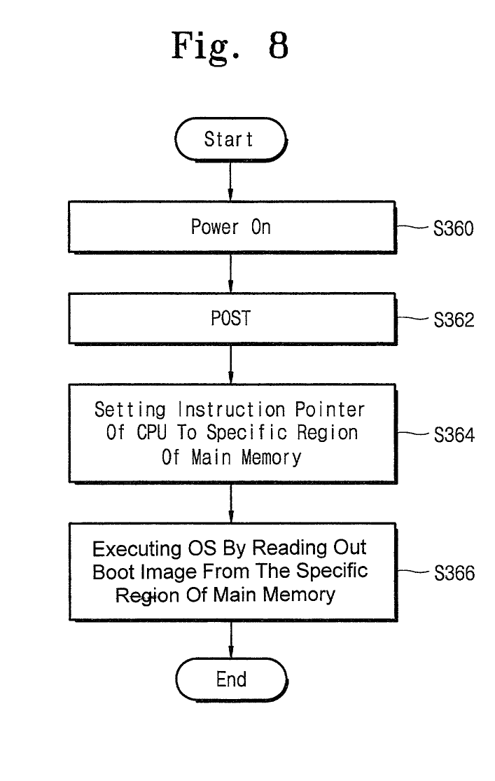

The operation of the computer system 300 is described as follows referring to FIGS. 7 and 8. FIG. 7 is a flow chart for illustrating a method for powering down the computer system 300 shown in FIG. 6, and FIG. 8 is a flow chart for illustrating a booting method of the computer system 300 shown in FIG. 6.

Referring first to FIG. 7, the control flow is used for generating a boot image. At step S350, it is determined whether the computer system 300 is powered off. If the computer system 300 is powered off, the control flow proceeds to step S352, wherein the boot image according to a specific state of the computer system 300 is read out from the hard disk drive 320.

Continually, at step S354, the read boot image 324 is loaded to the main memory 304. At step S356, an auxiliary power (for example, Vbat or Vsuspend) is supplied to the main memory 304, and a main power Vcc is shut off.

Referring next to FIG. 8, the computer system 300 is powered on in step S360 when the main power Vcc is supplied, and performs POST routine in step S362. Continually, at step S364, the IP of the CPU 302 is set to a specific region of the main memory 304. At step S366, the operating system is executed by reading out the boot image from the specific region. Therefore, the operating system can performs control functions.

As described above, an initial state of the main memory stored in the main memory is converted to a boot image, and the converted boot image is stored to a boot image storing device, when the computer system is powered off. Thus, the booting image is read out from the boot image storing device, when the computer system is powered on. Therefore, the booting time of the computer system can be reduced by using the boot image instead of loading respective device drivers in boot of the computer system. In addition, an auxiliary power is supplied to the main memory when a main power of the computer system is shut off. Therefore, the booting operation can perform more rapidly.

Although the invention has been described with reference to a particular embodiment, it will be apparent to one of ordinary skill in the art that modifications to the described embodiment may be made without departing from the spirit and scope of the invention. Thus, the true technical protection scope of the present invention must be determined by the attached claims.

What is claimed is:

1. A computer, comprising:
a central processing unit;
a main and/or auxiliary power supply for supplying main and/or auxiliary power of the computer;
a boot image storing device for storing a boot image of the computer;
a main memory for storing the boot image from the boot image storing device by receiving the auxiliary power when the main power is shut off; and
a composition memory for setting an instruction pointer of the central processing unit to a specific region of the main memory storing the boot image, wherein the central processing unit loads the boot image from the specific region of the main memory in response to the instruction pointer, allowing an operating system program can perform control functions.

2. The computer according to claim 1, wherein the auxiliary power supply is composed of alternative one of a battery and a suspend voltage supplying unit of the main power supply.

3. The computer according to claim 1, wherein the boot image storing device is a hard disk drive.

4. The computer according to claim 1, wherein the boot image storing device is a non-volatile memory device.

5. The computer according to claim 1, wherein the boot image storing device is a compact disk drive.

6. The computer of claim 1, wherein said composition memory is a BIOS ROM (Basic Input Output System Read Only Memory).

7. A method for powering down a computer receiving main and auxiliary power, the method comprising the steps of:
providing a central processing unit, a main memory, a basic input/output system memory and a boot image storing device;
determining whether the computer is powered down;
reading out a boot image from the boot image storing device;
storing the read boot image to the main memory;
supplying the auxiliary power to the main memory; and
shutting off the main power.

8. The method of claim 7, wherein said step of reading out a boot image from the boot image storing device is accomplished according to an initial state of the main memory.

9. The method of claim 8, wherein the step of reading out a boot image from the boot image storing device is accomplished when the computer is powered down.

10. A method for powering on a computer receiving main and auxiliary power, the method comprising the steps of:
providing a central processing unit with an instruction pointer, a main memory storing a boot image by receiving the auxiliary power when the main power is shut off, and a basic input/output system memory setting the instruction pointer
checking initializing steps and faults of the hardware components of the computer;
setting the instruction pointer of the central processing unit to a boot image storing region of the main memory; and
executing an operating system program by reading out the boot image from the boot image storing region of the main memory.

11. A method for booting a computer, comprising the steps of:
providing a central processing unit (CPU) having an instruction pointer and a memory for storing a boot image and a main memory;
reading out said boot image;
loading said boot image into said main memory;
setting said instruction pointer of said CPU to point to said boot image in main memory; and
executing an operating system by reading out said boot image from main memory.

12. The method of claim 11, said memory for storing said boot image prior to reading out said boot image being a boot image memory.

13. The method of claim 11, said memory for storing said boot image prior to reading out said boot image being a compact disk read only memory (CD-ROM).

14. The method of claim 11, wherein said step of reading out said boot image is accomplished when said boot image is in a compressed format.

15. The method of claim 14, further comprising the step of decompressing said boot image after said compressed boot image is read out.
